(19) United States
(12) Patent Application Publication
(10) Pub. No.: US 2015/0168606 A1
(43) Pub. Date: Jun. 18, 2015

(54) MICRO-LENS BASE RESIN FOR LED LIGHTGUIDE/WAVEGUIDE APPLICATIONS

(71) Applicant: GE Lighting Solutions, LLC, East Cleveland, OH (US)

(72) Inventors: Dengke CAI, Willoughby, OH (US); Gary Robert ALLEN, Euclid, OH (US); Thomas CLYNNE, Lakewood, OH (US); Jiawei LI, Avon, OH (US)

(73) Assignee: GE Lighting Solutions, LLC, East Cleveland, OH (US)

(21) Appl. No.: 14/107,131

(22) Filed: Dec. 16, 2013

(51) Int. Cl. G02B 1/04; B32B 37/18

(52) U.S. Cl. CPC G02B 1/048; B32B 37/182

(57) ABSTRACT

Provided is a micro-lens lightguide structure including a lightguide base resin layer. Also included is a nano-filler composite layer configured for overlaying the base resin, wherein the nano-filler includes a micro-lens pattern formed therein.

### TECHNICAL FIELD

The present invention relates generally to edge-lit panel lighting fixtures. More particularly, the present invention relates to protecting the surface of micro-lens patterned lightguides used in edge-lit panels.

### BACKGROUND

Edge-lit light emitting diode (LED) panels are becoming an increasingly common technology used, for example, in indoor lighting fixtures. As understood by those of skill in the art, light is transmitted from an LED array to a central area of an edge-lit panel through lightguides.

Among the advantages of edge-lit panels is the optical technology is embedded directly into the lightguide, optimizing light distribution, and optical efficiency. Also, their very thin physical profile enables the creation of correspondingly thin light fixtures. Additionally, as an LED-based fixture (i.e., flat-panel), edge-lit panels are generally more efficient, requiring fewer luminaires to produce more light for less energy.

In a conventional edge-lit panel, or luminaire, an optical protective sheet is used to cover a surface of an optical lightguide used in an LED flat-panel. As understood by those of skill in the art, the lightguide generally includes a micro-lens pattern guide distribution of the light. This protective sheet shields the lightguide against scratches, the effects of dust, and other contaminants.

Unfortunately, protective sheets provide this shielding at the expense of optical performance. More specifically, these layers generally decrease the transparency of the surface of the lightguide, ultimately reducing the optical characteristics of the LED fixture.

### I. SUMMARY OF THE EMBODIMENTS

Given the aforementioned deficiencies, a need exists for methods and systems that provide improved surface abrasion resistance of lightguides while maintaining maximum transparency and minimum optical loss in lightguide transmissions.

In certain circumstances, an embodiment includes a micro-lens lightguide structure including a lightguide base resin layer. A nano-filler composite layer configured for overlaying the base resin, wherein the nano-filler includes a micro-lens pattern formed therein.

Illustrious embodiments of the present invention provide a resilient nano-filler polymer coating without the need of protection sheets. This coating can be applied and used to increase the surface scratch resistance of the base polymer resin for a lightguide micro-lens pattern. The base polymer is usually formed of acrylic, epoxy, silicon, or the like.

In the embodiments, a micro-lens lightguide structure includes a lightguide base resin constructed of an acrylic-like material, along with a nano-filler polymer layer, such as a polymethyl methacrylate (PMMA) material. A micro-lens pattern is formed within the nano-filler polymer layer. This nano-filler polymer layer can be coated onto the lightguide base resin, via screen printing and doctor blading transfer molding to create the micro-lens pattern. Use of a nano-filler polymer coating eliminates the need for protective sheets. Thus, the overall weight of the micro-lens lightguide structure can be reduced while maintaining optical efficiency.

Further features and advantages, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### II. BRIEF DESCRIPTION OF THE DRAWINGS

Exemplary embodiments may take form in various components and arrangements of components. Exemplary embodiments are illustrated in the accompanying drawings, throughout which like reference numerals may indicate corresponding or similar parts in the various figures. The drawings are only for purposes of illustrating preferred embodiments and are not to be construed as limiting the invention. Given the following enabling description of the drawings, the novel aspects of the present invention should become evident to a person of ordinary skill in the art.

FIG. 1 is an illustration of an LED panel lighting fixture in which embodiments of the present invention can be practiced.

FIG. 2 is a more detailed illustration of the LED panel lighting fixture illustrated in FIG. 1.

FIG. 3 is a detailed illustration of a conventional lightguide protection arrangement.

FIG. 4 is a detailed illustration of a micro-lens lightguide structure constructed and arranged in accordance with an embodiment of the present invention.

FIG. 5 is an illustration of an exemplary graph 600 of optical transmission characteristics of various nano-filler blended polymer hardcoating coated lightguide base resinconstructed in accordance with the embodiment.

FIG. 6 is an illustration of transparency performance results of a nano-filler blended polymer hardcoating coated PMMA in comparison to a regular PMMA and PC (polycarbonate) based material in accordance with the embodiment after sand scratching test.

FIG. 7 is an illustration of a hybrid polymer to construct a single layer lightguide structure in accordance with a second embodiment of the present invention.

### III. DETAILED DESCRIPTION OF THE EMBODIMENTS

While exemplary embodiments are described herein with illustrative embodiments for particular applications, it should be understood that the invention is not limited thereto. Those skilled in the art with access to the teachings provided herein will recognize additional modifications, applications, and embodiments within the scope thereof and additional fields in which the multi-reflector design described herein would be of significant utility.

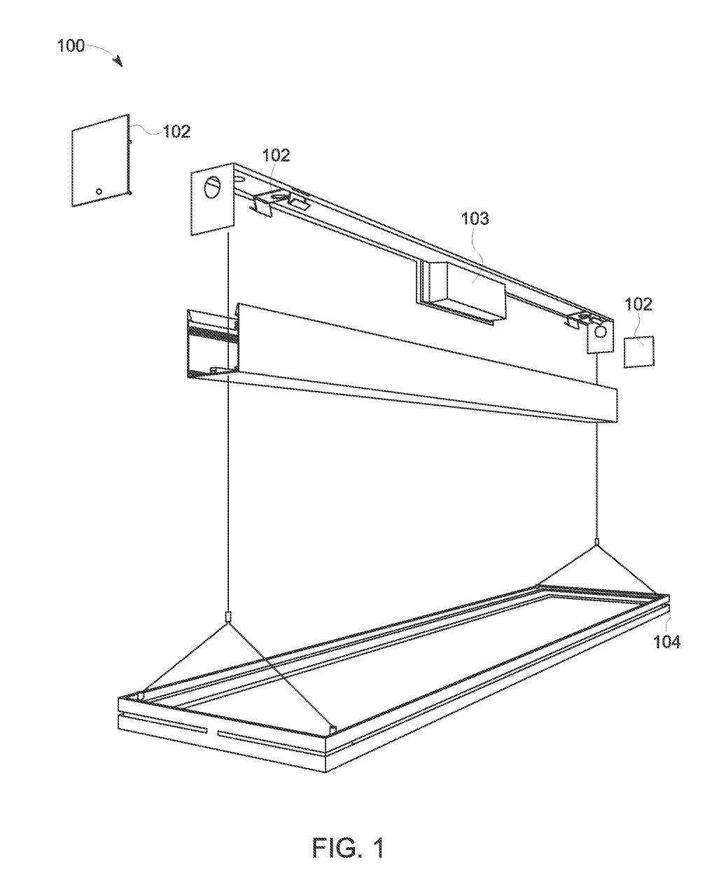

FIG. 1 is an illustration of an exemplary LED panel lighting fixture 100 in which embodiments of the present invention can be practiced. The LED panel lighting fixture 100 is commonly used office settings such as conference and meeting rooms, computer aided design (CAD) workstations, reception areas, archives, etc. By way of example, and not limitation, the lighting fixture 100 is a 1×4 recessed troffer.

The LED panel lighting fixture 100 includes standard components, such as a power supply unit (PSU) box 102, which houses a driver 103 for the lighting 100. The driver 103 provides power LEDs within a lighting module 104, illustrated in greater detail below.

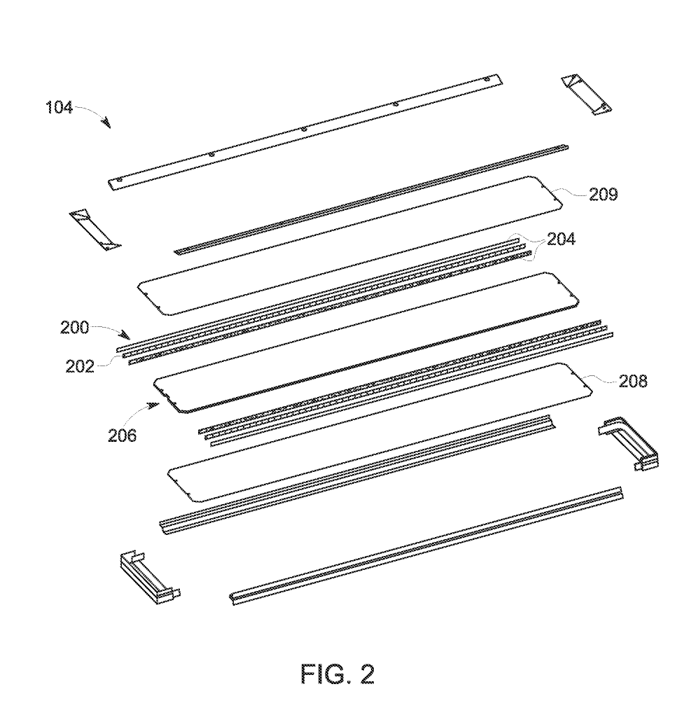

FIG. 2 is a more detailed illustration of the lighting module 104 of FIG. 1. The lighting module 104 includes an LED bar 200 including LEDs 202 mounted within reflector cups 204. The LEDs 202 of the LED bar 200 are positioned to surround a lightguide (e.g., waveguide) 206. The lightguide 206 directs light, produced by the LED bar 202, to areas of the lighting module 104.

The light is distributed via a micro-lens pattern (shown below) embedded on a surface of the lightguide 206, and through protective sheets (i.e., diffuser) 208 and 209. The optical protective sheets 208 and 209 overlay, or are affixed to a surface of the lightguide 206. The optical protective sheets 222 shield the lightguide 206 from debris and other contaminants.

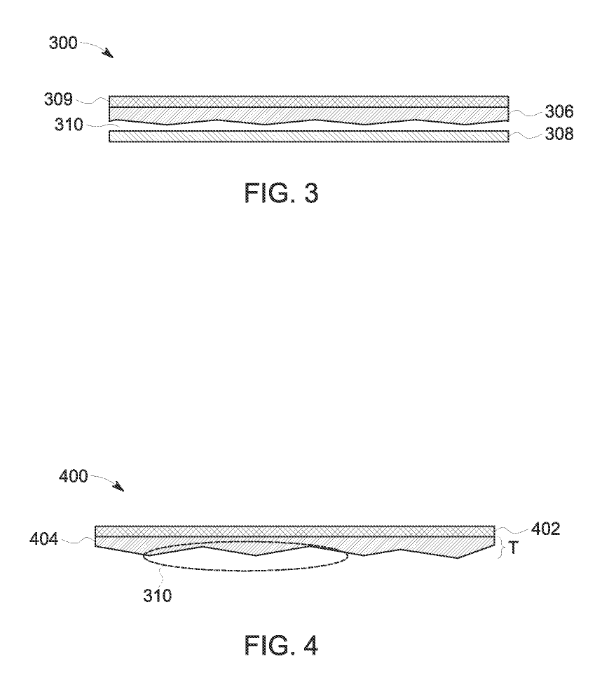

FIG. 3 is a detailed illustration of a conventional lightguide protection arrangement 300. The lightguide arrangement 300 is similar to the lightguide arrangement 104 (e.g., the optical protective sheets 208 and 209 and the lightguide 206) of FIG. 2. That is, the lightguide arrangement 300 includes a protective sheet (e.g., clear acrylic sheet) 308 shielding a top side of the lightguide 306 from debris and other contaminants. A micro-lens pattern 310, embedded on a surface of the lightguide 306, distributes light produced by a light source, such as LEDs. As depicted in FIG. 3, however, an additional protective sheet 309 shields a bottom side of the lightguide 306. It is noted, however, that some conventional lightguide arrangements only use a single protective sheet.

In the conventional lightguide protection arrangement 300, the surface of the lightguide 306 is extremely susceptible to damage via scratches, cleaning solvents, human touch, debris, and other contaminants etc. For example, the slightest scratch of the lightguide 306 can create light leakages resulting in suboptimal performance.

A contributing factor to this susceptibility is that conventional surface micro-lens patterns, such as the micro-lens pattern 310, are typically formed of relatively weak base resin materials. This weakness creates the need for protective sheets. In the conventional lightguide arrangement 300, the bottom protective sheet 308 and the top protective sheet 309 are collectively referred to as diffusers. In FIG. 3, the bottom protective sheet 308 and the top protective sheet 309 form a sandwich type arrangement to shield the lightguide 306 from the degrading effects of contaminants.

A significant disadvantage in using protective sheets, such as the top protective sheet 308, is that these sheets create their own optical transmission losses. For example, the top protective sheet 308 typically creates about a 4% loss in reflectivity in the surface of the lightguide 306. The majority of this loss is attributed to TIR (total internal reflection) effect between the micro-lens pattern and the protective sheet. Additionally, protective sheets are generally extraordinarily expensive due to improved surface abrasion resistance. Embodiments of the present invention offer an alternative approach to protecting and preserving the integrity of the micro-lens patterns on lightguide surfaces.

In particular, illustrious embodiments of the present invention provide a resilient nano-filler polymer coating without the need of protection sheets. This coating can be applied and used to increase the surface scratch resistance of the base polymer resin for a lightguide micro-lens pattern. The base polymer is usually formed of acrylic, epoxy, silicon, or the like. This nano-filler polymer is a clear polymer coating containing nano-fillers and actually forms the micro-lens pattern.

A nano-filler polymer micro-lens pattern, in accordance with the embodiments, can be constructed and directly deposited onto the lightguide substrate, or base polymer, using any one of a number of techniques, such as molding, doctor blading, screen printing (i.e., ink impression), and the like. These techniques are well understood by those of skill in the art.

A nano-filler particle constructed in accordance with the embodiments desirably has a average particle size less than about 100 nanometers (nm). In this particle size range, the nano-filler would not affect the resin's transparency. At the same time, the resin's surface scratch resistance will be substantially improved due to bridge effect due to nano-filler in polymer, which strengths the polymer molecular chains.

More specifically, the nano-filler (i.e., inorganic nano-composite) polymer micro-lens material is used to form an optical diffusive pattern and can be applied as a coating atop the lightguide substrate. Since it can have substantially the same RI as the lightguide substrate, it is not necessary to reshape the micro-lens to satisfy a light distribution requirement. Additionally, the nano-filler polymer enhances the surface abrasion resistance of the lightguide at thicknesses of above 1 micrometers (um). This material also can have tunable surface properties like hydrophobic or hydrophilic characteristics that can inherently protect against dust and facilitate self-cleaning etc.

FIG. 4 is a detailed illustration of a micro-lens lightguide structure 400 constructed in accordance with an embodiment of the present invention. The structure 400 includes a lightguide base resin 402 constructed of an acrylic-like material, along with a nano-filler polymer layer 404, such as a PMMA material. A micro-lens pattern (e.g., the micro-lens pattern 310) is formed within the nano-filler polymer layer 404.

The nano-filler polymer layer 404 can be coated onto the lightguide base resin 402, via screen printing and doctor blading transfer molding to create the micro-lens pattern 310. Use of the nano-filler polymer coating 404 eliminates the need for protective sheets, such as the protective sheets 308 and 309 illustrated in FIG. 3. Thus, the overall weight of the micro-lens lightguide structure 400 can be reduced while simultaneously optimizing optical efficiency.

Nano-filler can be additional additives in polymer or self-grown nano particles during crosslinking process of base polymer. By way of example only, and not limitation, the polymer coating 404 can be formed of nano-filler materials such as silicon dioxide (SiO2-x), titanium oxide (TiO2), and aluminum oxide (Al2O3), and the like. As noted above, a thickness (T) of the polymer coating 404 is desirably above 1 um. The nano-filler particle size is desirably below 100 nm. Restricting the particle size of nano-filler to less than about 100 nm increases the surface abrasion resistance, prevents particle scattering, and maintains good transparency of the surface of the base resin 402, with minimal impact to light output or total lumens.

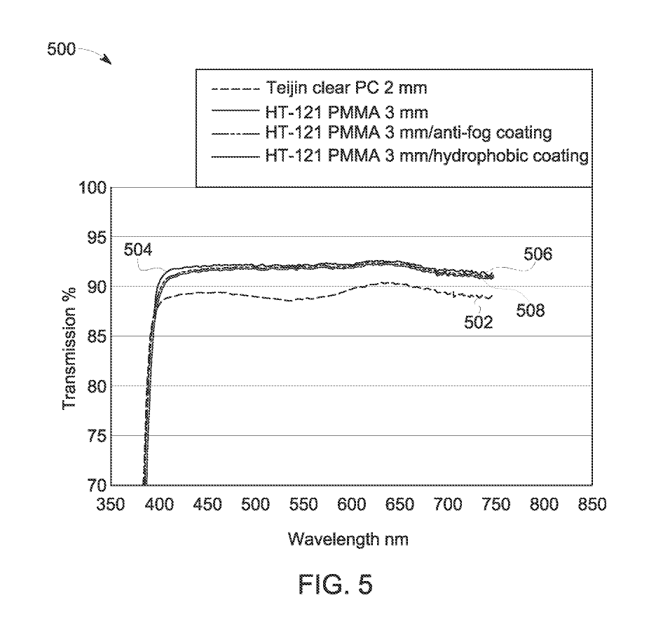

FIG. 5 is an illustration of an exemplary graph 500 of optical transmission characteristics of micro-lens lightguide structures constructed in accordance with the embodiment. In the graph 500, a snapshot of transmission capabilities of various materials, when used as a coating, is displayed for various light wavelengths. For example, teijin clear PC 2 mm 502, HT-121 PMMA 3 mm 504, which can be as base material of lightguide, HT-121 PMMA 3 mm/hydrophilic anti-fog coating 506, and HT-121 PMMA 3 mm/hydrophobic coating 508, which both coating have improved surface abrasion resistance are shown. Any of the materials 504-508 can be used in the embodiments, with each achieving greater than 90% optical transmission and very minimum effect on lightguide transparency.

The nano-filler blended polymer coating 404 can be chemically bonded with the base resin 402 after polymerization under ultraviolet (UV) light or heat, thus forming superior adhesion via covalent bonding, and good thickness uniformity. The polymer coating 404 exists as rigid micropattern dots (e.g., ink based material) among polymer chains to increase the surface scratch resistance of the base resin 402. Overlaying the base resin 402 with the nano-filler polymer coating 404.

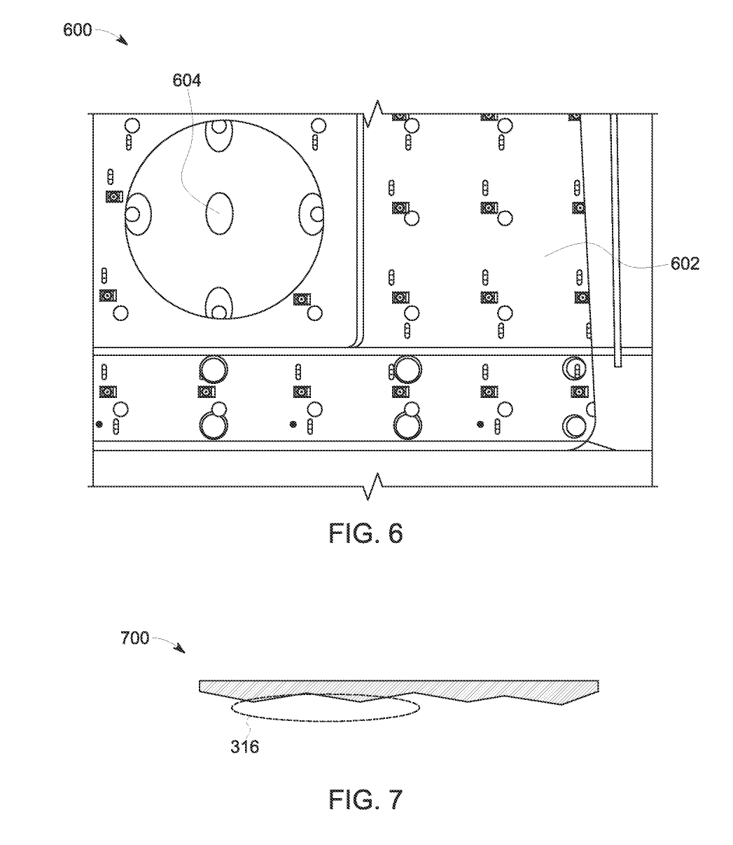

FIG. 6 is an illustration of transparency performance results 600 of a nano-filler blended polymer coating coated PMMA 602 (as used in the illustrious embodiments) in comparison to a regular PMMA based material 604. In FIG. 6, after a 500 cycle sand scratching test, the nano-filler blended polymer coating coated PMMA 602 displayed much better transparency than the regular PMMA 604. For example, the nano-filler blended polymer coating coated PMMA 602 displayed less haze than the regular PMMA 604. As understood by those of skill in the art, haze is a measure of scratch resistance after sanding scratching test.

Additionally, the application technique of the nano-filler polymer coating 404 can be modified to adjust the surface properties of the base resin 402 in accordance with customer and/or user requirements. More particularly, additives to the nano-filler polymer coating 404 can create hydrophobic and hydrophilic surface properties of the base resin 402.

By way of example, the underlying nano-filler polymer material is non-solvent based. Its viscosity can be increased by further adding nano-fillers. Also, since it is non-solvent based type coating, after molding process fabricated micropattern dots (nano/micro structure) can keep very good fidelity with mold structure.

Hydrophobic surface features are generally water repellent, inherently protect against dust, thus enhancing the self-cleaning characteristics of the micro-lens lightguide structure 400. Hydrophilic surface features are more water-soluble, and as such, can reduce the possibility of being damage during cleaning. Surface tension characteristics can be added or modified based upon customer requirements.

FIG. 7 is an illustration of a hybrid polymer including a fluoropolymer, such as polyvinylidene fluoride (PVDF), to construct a single layer lightguide structure 700 having a micro-lens pattern 310 formed therein. As understood by those of skill in the art, PVDF has exceptional chemical resistance, UV resistance, thermal stability, and low surface energy or inherent hydrophobicity. By way of example, these characteristics are suitable for extensive use as a coating material for outdoor lighting applications.

More specifically, a hybrid polymer including a fluoropolymer like PVDF and acrylate polymer like PMMA can be used as a based material for various optical components with surface micro/nano structures. Such structures can include lightguides, optical lens, refractors, diffusers, and the like. By way of example, the ratio between acrylate and fluoropolymers polymers can enhance the performance of the hybrid polymer on surface abrasion resistance.

PMMAs and PVDFs are completely miscible in their molten state. During a plastic molten state, a low surface PVDF can flow above to the PMMA, blending a hydrophobic layer onto the PMMA after cool down. Generally, blending the PVDF with the PMMA improves the PMMA's surface hydrophobicity, blue and UV resistance. It also improves the PMMA's thermal stability. Additionally, controlling the percentage of crystallinity of PVDF in PMMA can also improve the hardness of PMMA. This hybrid polymer is also moldable, thus enabling its use as a base material for both substrates and micro/nano structured elements. A PVDF-PMMA hybrid polymer is particularly well-suited for use as a float light panel.

PVDF-PMMA hybrid polymers can not only bring negative influence on PMMA transmission but enhance surface scratching resistance of high density PMMA (e.g., Arkema HT121 for use as a single layer circular float), but also provides hydrophobic surface features to flat panels due to low surface energy from fluoropolymer component.

Alternative embodiments, examples, and modifications which would still be encompassed by the invention may be made by those skilled in the art, particularly in light of the foregoing teachings. Further, it should be understood that the terminology used to describe the invention is intended to be in the nature of words of description rather than of limitation.

Those skilled in the art will also appreciate that various adaptations and modifications of the preferred and alternative embodiments described above can be configured without departing from the scope and spirit of the invention. Therefore, it is to be understood that, within the scope of the appended claims, the invention may be practiced other than as specifically described herein.

We claim:

1. A micro-lens lightguide structure, comprising:
a lightguide base resin layer; and
a nano-filler containing polymer composite layer configured for overlaying the base resin, the nano-filler containing polymer composite layer having a micro-lens pattern formed therein.

2. The micro-lens lightguide structure according to claim 1, wherein the nano-filler containing polymer composite includes materials which have composition forming at least one of silicon dioxide (SiO2), titanium oxide (TiO2-x), zirconium dioxide (ZrO2-x), and aluminum oxide (Al2O3-x).

3. The micro-lens lightguide structure according to claim 1, wherein the nano-filler average particle size is less than about 100 nano-meters.

4. The micro-lens lightguide structure according to claim 1, wherein the micro-lens pattern is formed using at least one from the group including printing, embossing, casting and molding.

5. The micro-lens lightguide structure according to claim 1, wherein the nano-filler composite layer is bonded with the lightguide base resin layer after polymerization using at least one from the group including under ultraviolet (UV) light or heat.

6. A micro-lens lightguide structure including a lightguide base resin layer, comprising:
a nano-filler containing polymer composite layer configured for overlaying the base resin;
wherein the nano-filler containing polymer composite layer includes a micro-lens pattern formed therein.

7. The micro-lens lightguide structure according to claim 6, wherein the nano-filler composite includes materials which have compositions forming in the least of like silicon dioxide (SiO2-x), titanium oxide (TiO2-x), zirconium dioxide (ZrO2-x) and aluminum oxide (Al2O3-x).

8. The micro-lens lightguide structure according to claim 8, wherein the nano-filler average particle size is less than about 100 nano-meters.

9. The micro-lens lightguide structure according to claim 8, wherein the micro-lens pattern is formed using at least one from the group including printing, embossing, casting, and molding.

10. The micro-lens lightguide structure according to claim 9, wherein the nano-filler composite layer is bonded with the lightguide base resin layer after polymerization using at least one from the group including under ultraviolet (UV) light or heat.

11. A method for constructing a micro-lens lightguide structure including a lightguide base resin layer, the method comprising:
overlaying the base resin layer with a nano-filler containing polymer composite layer;
wherein the nano-filler containing polymer composite layer includes a micro-lens pattern formed therein.

12. The method of claim 11, wherein the nano-filler composite includes materials which have compositions forming at least one of silicon dioxide (SiO2-x), titanium oxide (TiO2-x), zirconium dioxide (ZrO2-x), and aluminum oxide (Al2O3-x).

13. The method of claim 11, wherein the nano-filler average particle size is less than about 100 nano-meters.

14. The method of claim 11, wherein the micro-lens pattern is formed using at least one from the group including printing, embossing, casting and molding.

15. The method of claim 11, further comprising bonding the nano-filler composite layer with the lightguide base resin layer after polymerization using at least one from the group including under ultraviolet (UV) light or heat.
